(19) United States
(12) Patent Application Publication
(10) Pub. No.: US 2008/0040339 A1
(43) Pub. Date: Feb. 14, 2008

(54) Learning question paraphrases from log data

(75) Inventors: Ming Zhou, Beijing (CN); Shiqi Zhao, Harbin (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/500,224

(22) Filed: Aug. 7, 2006

(51) Int. Cl. G06F 17/30

(52) U.S. Cl. 707/5

(57) ABSTRACT

Question paraphrases useful for systems such as natural language processing and information retrieval are ascertained by examining log data from a computer based information source such as an Internet search engine or a computer based encyclopedia.

### BACKGROUND

The discussion below is merely provided for general background information and is not intended to be used as an aid in determining the scope of the claimed subject matter.

With the explosive growth of the Internet, the ability to obtain information on just about any topic is possible. Furthermore, an Internet search typically will provide not just one document relevant to the search query, but rather, a multitude if not hundreds of relevant documents. In many instances, each document will convey the same information in a different manner. Likewise, different search queries may result in the same or substantially the same results. The alternative ways to convey the same information is called a “paraphrase.” In recent years, there has been growing research interest in paraphrasing since it is of great importance in many applications. In natural language processing (“NLP”) for instance, natural language generation, multi-document summarization, question and answering systems (“QA”), and automatic evaluation of machine translation are just a few applications that can include paraphrase scenarios.

One particular form of paraphrases are question paraphrases. In short, question paraphrases are questions in different formats that actually mean the same thing, and thus, have the same answer. If an input question can be expanded with its various paraphrases, the recall of answers can be improved. This can be advantageous in various applications such as NLP applications, for instance QA systems that provide an answer to a question as well as information retrieval that provides a list of documents to a query.

### SUMMARY

This Summary and the Abstract are provided to introduce some concepts in a simplified form that are further described below in the Detailed Description. The Summary and Abstract are not intended to identify key features or essential features of the claimed subject matter, nor is it intended to be used as an aid in determining the scope of the claimed subject matter. In addition, the description herein provided and the claimed subject matter should not be interpreted as being directed to addressing any of the short-comings discussed in the Background.

Question paraphrases useful for natural language processing and information retrieval based system are ascertained by examining log data from a computer based information source such as an Internet search engine or a computer based encyclopedia. In one exemplary embodiment, identifying pairs of questions having substantially the same semantic meaning includes classifying the questions from the data log according to question type. Question types are general inquiries related to who, what, when, where, why, and how. In yet a further embodiment, each of the sets of questions grouped based on question type are also partitioned into smaller clusters indexed or based on words contained in each of the questions.

Identifying question paraphrases can be based on a number of features including, but not limited to, ascertaining similarity of the information indicative of the answers to the questions; ascertaining syntactic similarity of the questions; and/or ascertaining similarity of translations of the questions. In one embodiment, analysis of the questions with respect to these features is performed on a cluster by cluster basis.

### BRIEF DESCRIPTION OF THE DRAWINGS

FIG. 1 is a block diagram of a system for generating question paraphrases.

FIG. 2 is a flowchart of a method for generating question paraphrases.

FIG. 3 is a block diagram of a question paraphrase generating module.

FIG. 4 is an exemplary computing environment.

### DETAILED DESCRIPTION

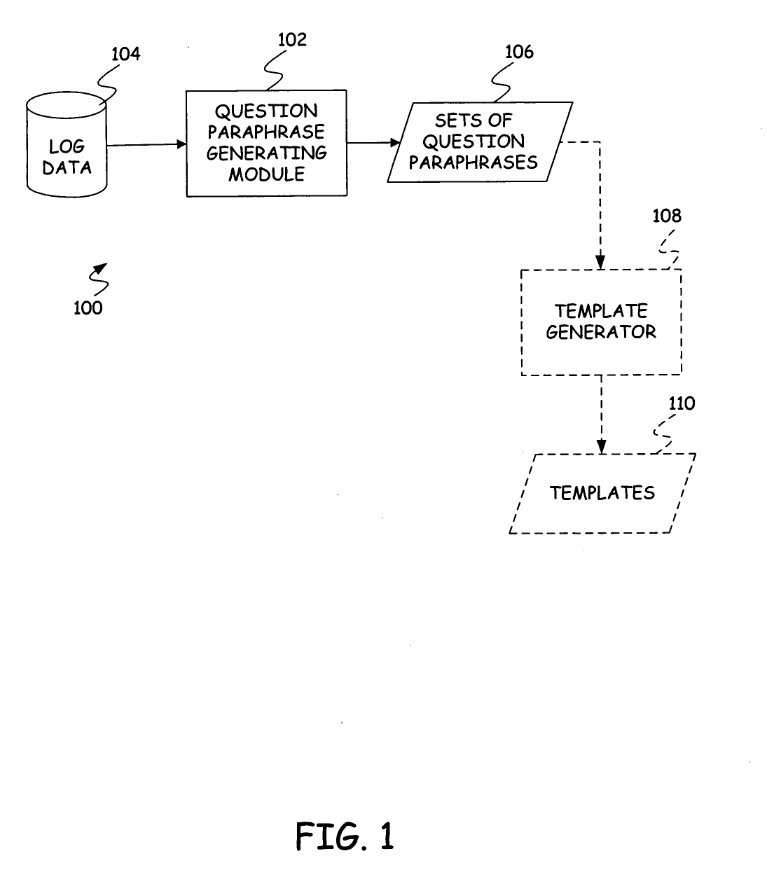

One general concept herein described is a system and method for obtaining question paraphrases from log data. Referring to FIG. 1, a question paraphrase generation system 100 includes a question paraphrase generating module 102 that accesses a data log 104 and provides as an output sets of associated question paraphrases 106 having essentially the same meaning. Stated another way, each paraphrase of the set of question paraphrases 106 comprises at least two questions having different words but embodying substantially the same semantic inquiry.

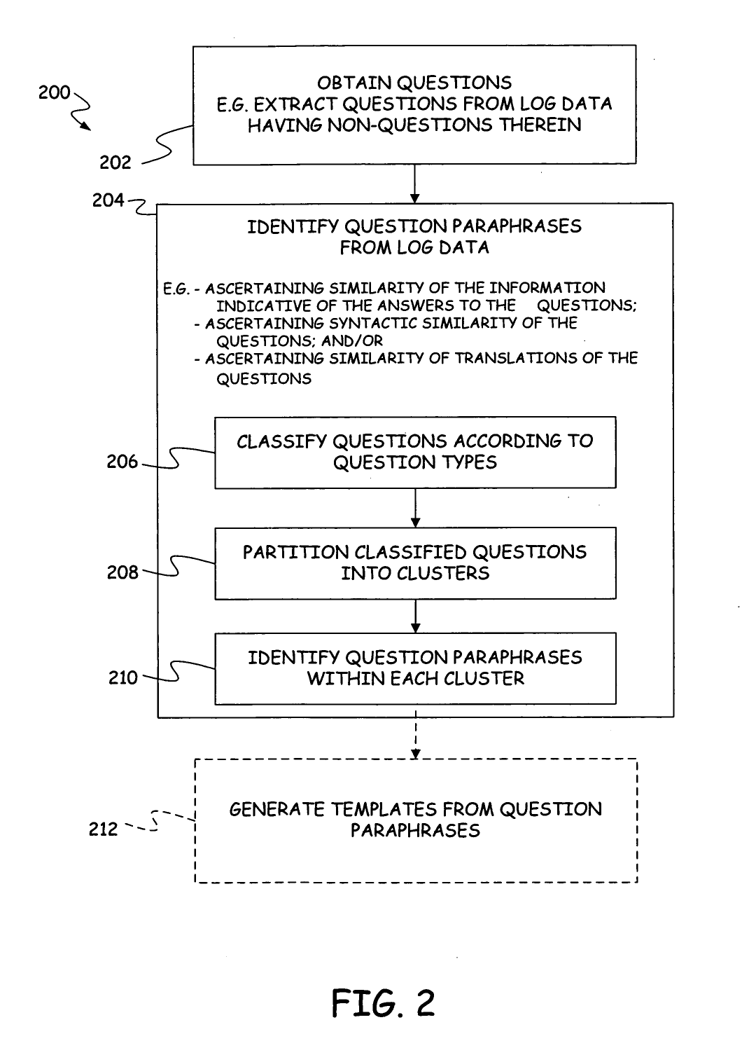

FIG. 2 illustrates an overall method 200 for obtaining the sets of question paraphrases 106. At step 202, questions are obtained from log data 104, such as through extraction where the log data 104 has non-questions therein. At step 204, the question paraphrases are identified, for example, by ascertaining similarity of the information indicative of the answers to the questions; by ascertaining syntactic similarity of the questions; and/or by ascertaining similarity of translations of the questions.

In the exemplary embodiment described herein, step 204 includes classifying the extracted questions according to question type at step 206; partitioning the classified question into clusters at step 208; and identifying all question pairs (each pair being a paraphrase) within each cluster at step 210. Each of the foregoing steps will be described further below. Optionally, for the sake of completeness, templates 108 can be generated from the set of question paraphrases 106 with a template generator 110 at step 212, as illustrated in FIG. 1.

Referring back to step 202, questions are extracted from log data 104. At this point it should be noted that log data 104 can take numerous forms. For example, log data 104 can be obtained from log data associated with computer based information sources such as Internet search engines or computer based encyclopedias, for example, Internet or online based encyclopedias. For purposes of explanation only and not limitation, the description herein provided will reference log data obtained from an online encyclopedia.

Besides including the question or query, log data 104 can also include information indicating which document the user selected for review. A small segment of query sessions of an online encyclopedia log is provided below.

. . .

Plant Cells: #761568511

Malaysia: #761558542

rainforests: #761552810

what is the role of a midwife?: #761565842

why is the sky blue: #773456711

. . .

In the examples above, each query comprises the text prior to the colon, while the document selected by the user for the associated query is identified by the number following the number sign.

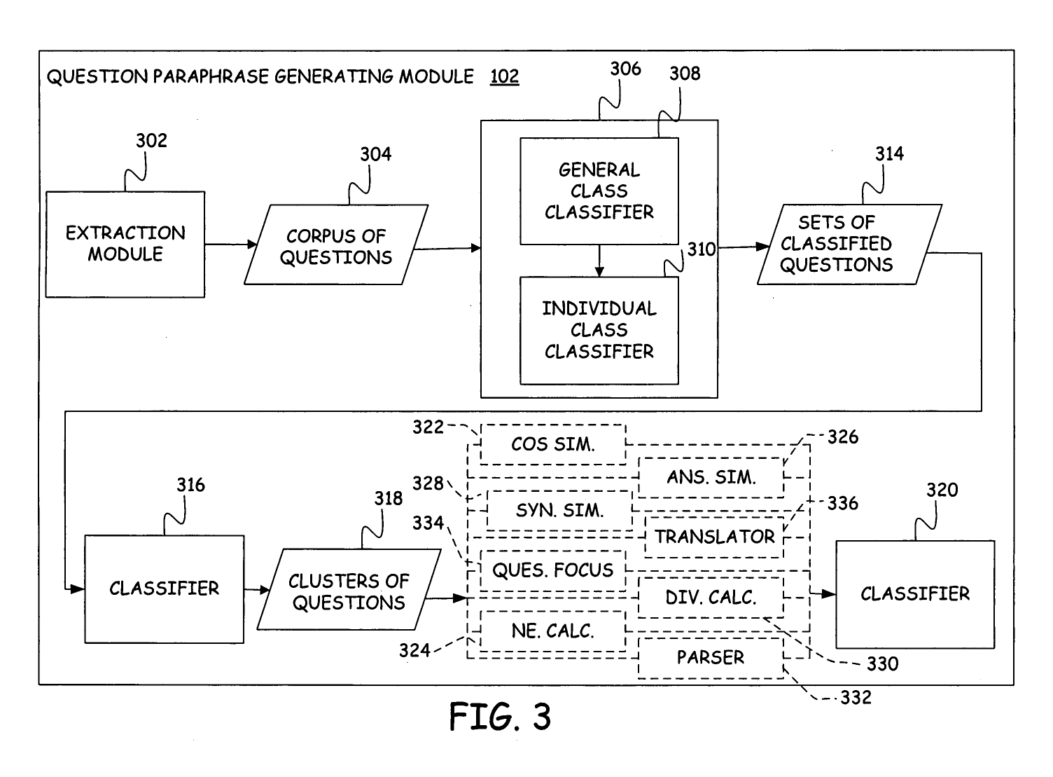

Although the number of query sessions is quite substantial in a typical log, most of the query sessions are keywords or phrases rather than well-formed questions. As indicated above, step 202 can include extraction of questions from log data 104. For example, extraction can be based on whether or not the query contains a question mark, and/or based on other heuristics. For instance, simple heuristic rules can stipulate that the query has to be three or more words in length and one of the words must be a question word (i.e. who, what, when, where, why, and how). In FIG. 3, question paraphrase generating module 102 is illustrated in detail where extraction module 302 exemplifies obtaining a corpus of questions 304 from the log data 104.

In principle, any pair of questions in the corpus of questions 304 should be considered when identifying paraphrases. However, since the question corpus 204 can easily contain thousands of questions, it is not practical to identify paraphrases for each and every different pair of questions. Therefore, in the exemplary embodiment described herein, a two-step process, involving question type classification (step 206) and question partition (step 208), is employed to divide the question corpus 304 into thousands of small clusters, where the identification of paraphrases is performed within each cluster at step 210.

The question type is an important attribute of a question, which usually indicates the category of its answer. Based on the observation that two questions with different question types can hardly be paraphrases, questions in the corpus are first classified into 50 different types (from six general classes) using a widely accepted question type taxonomy provided below:

1: abbreviation, explanation
2: animal, body, color, creative, currency, disease, event, food, instrument, language, letter, other, plant, product, religion, sport, substance, symbol, technique, term, vehicle, word
3: definition, description, manner, reason
4: group, individual, title, human-description
5: city, country, mountain, other, state
6: code, count, date, distance, money, order, other, period, percent, speed, temperature, size, weight

Referring to FIG. 3, a classifier 306, herein a two-level classifier, can be used to classify the questions using the foregoing taxonomy. In the illustrated embodiment, classifier 306 includes a general class classifier 308 that classifies the questions of corpus 304 into six general classification sets In particular, each set corresponds to a type of question word (i.e. who, what, when, where, why, and how). At the second level, a second classifier 310 then classifies each of the six general classes into its corresponding individual classes, providing in this illustrative embodiment, 50 sets of classified questions 314. In one embodiment, classifier 310 can be a Support Vector Machine (SVM) classifier that is trained for each set using the words as features. When classifying new questions, the process closely mimics the training steps. Given a new question, its question word is first extracted. A feature vector is then created using the same features as in the training. Finally, the SVM corresponding to the question word is used for classification.

Although not necessary, the two-level classifier 306 is employed because the question words are prior knowledge and imply a great deal of information about the question types. The two-level classifier 306 thus can make better use of this knowledge than a flat classifier that uses the question words simply as classification features.

At step 208, sets of questions 314 within each of the 50 individual classes are further partitioned into more fine-grained clusters, which is based on the assumption that two questions having no common word have little chance to be paraphrases.

Referring to FIG. 3, a clustering module 316 receives the sets of classified questions 314 and provides as an output clustered questions 318. Specifically, given a content word w, all questions within each individual question class that contain w are put into the same cluster (if desired, this cluster can be considered “indexed” by w). Generally, if a question contains n different content words, it will be put into n clusters. In this step, the set of question 314 obtained in step 206 can be further partitioned into thousands of clusters, depending on the number of questions available.

At step 210, all question pairs comprising paraphrases within each cluster are identified. A classifier 320 (FIG. 3) is used to identify paraphrases within the clusters 318. If a cluster has n questions, n*(n−1)/2 question pairs are generated by pairing any two questions in the cluster. For each pair, the classifier learns whether they are paraphrases (which can be identified as the classifier 320 outputting a “1”) or not (which can be identified as the classifier outputting “−1”).

In order to identify paraphrases, classifier 320 can use one or all of the following features:
Cosine Similarity Feature (CSF): The cosine similarity of two questions is ascertained by module 322 after stemming and removing stopwords. Suppose q1 and q2 are two questions, Vq1 and Vq2 are the vectors of their content words. Then the similarity of q1 and q2 is calculated as in Equation (1).

$$Sim ( {q}_{1} , {q}_{2} ) = cos ( {V}_{q 1} , {V}_{q 2} ) = \frac{〈 {V}_{q 1} , {V}_{q 2} 〉}{‖ {V}_{q 1} ‖ ‖ {V}_{q 2} ‖} \qquad ( 1 )$$

Where <V_{q1},V_{q2}> denotes the inner product of two vectors and ∥•∥ denotes the length of a vector.
Named Entity overlapping Feature (NEF): Since named entities (e.g. person names, locations, time . . . ) should be preserved across paraphrases, the overlapping rate of named entities in two questions can be ascertained by module 324 and as a feature. The overlapping rate of two sets can be computed as in Equation (2):

$$OR ( {S}_{1} , {S}_{2} ) = \frac{\vert {S}_{1} ⋂ {S}_{2} \vert}{max ( \vert {S}_{1} \vert , \vert {S}_{2} \vert )} \qquad ( 2 )$$

Where S1 and S2 are two sets and |.| is the cardinality of a set.
User Select Feature (USF): If two questions often lead to the same document selected by the same or different users, then these two questions tend to be similar. This new feature of user select similarity of two questions can be ascertained by module 326 using, for example, Equation (3).

$${Sim}_{user\_select} ( {q}_{1} , {q}_{2} ) = \frac{RD ( {q}_{1} , {q}_{2} )}{max ( r d ( {q}_{1} ) , r d ( {q}_{2} ) )} \qquad ( 3 )$$

Where rd(.) is the number of selected documents for a question and RD(q₁,q₂) is the number of selected documents in common.
Synonyms Feature (SF): The pair of questions is expanded with the synonyms extracted from a lexical database such as “WordNet” by module 328, which organizes nouns, verbs, adjectives, adverbs, etc. into sets. Specifically, a question q can be expanded to q′, which contains the content words in q along with their synonyms. Then for the expanded questions, the overlapping rate is calculated and selected as a feature.
Unmatched Word Feature (UWF): The above features measure the similarity of two questions, while the unmatched word feature ascertained by module 330 is designed to measure the divergence of two questions. Given questions q1, q2 and q1's content word w1, if neither w1 nor its synonyms can be found in q2, w1 is defined as an unmatched word of q1. The unmatched rate can be calculated such as in Equation (4) and used as a feature.

UR(q₁,q₂)=max(ur(q₁),ur(q₂)) (4)

### Where ur(.) is the percentage of unmatched words in a question.

Syntactic Similarity Feature (SSF): In order to extract the syntactic similarity feature, the question pairs are parsed by a shallow parser 332 whereby the key dependency relations can be extracted from a sentence. By way of example, four types of key dependency relations can be defined: subject (SUB), object (OBJ), attribute (ATTR), adverb (ADV). For example, for the question “What is the largest country”, the shallow parser will generate (What, is, SUB), (is, country, OBJ), (largest, country, ATTR) as the parsing result. As can be seen, the parsing result of each question is represented as a set of triples, where a triple comprises two words and their syntactic relation. The overlapping rate of two questions' syntactic relation triples is selected as their syntactic similarity and used as a new feature.
Question Focus Feature (QFF): The question focus can be viewed as the target of a question. For example, in the question “What is the capital of China?” the question focus is “capital”. Two questions are more likely to be paraphrases if they have identical question focus. The question focuses can be extracted by module 334 using simple predefined rules such as the word following “What is” is the focus of the question. In one embodiment, the QFF feature has a binary value, namely, 1 (two questions have identical focus) or 0 (otherwise).
Translation Similarity Feature (TSF): Translation information can also be useful to identify paraphrases. Available Internet or online translators can be used by module 336 to generate translations in a selected language different than the language of one or both of the question sentences. The cosine similarity of the translation vectors of two questions is then calculated and provides a new feature.

It has been found in experiments that the input data for paraphrase identification is rather unbalanced, in which, only a very small proportion of the question pairs are paraphrases. There are known methods for dealing with classification with unbalanced data including using Positive Example Based Learning (PEBL) (Yu H., Han J. and Chang KC.-C. 2002. PEBL: Positive-Example Based Learning for Web Page Classification Using SVM. In Proc. of ACM SIGKDD Int. Conf. on Knowledge Discovery and Data Mining), one-class SVMs (Manevitz L. M. and Yousef M. 2001. One-Class SVMs for Document Classification. Journal of Machine Learning Research, 2(December): 139-154) and Perceptron Algorithm with Uneven Margins (PAUM) (Li Y., Zaragoza H., Herbrich R., Shawe-Taylor J. and Kandola J. 2002. The Perceptron Algorithm with Uneven Margins. In Proc. of ICML 02).

With respect to PAUM, it is an extension of the perceptron algorithm, which is specially designed to cope with two class problems where positive examples are very rare compared with negative ones, as is the case in the paraphrase identification task. PAUM considers the positive and negative margins separately. The positive (negative) margin γ±1(w,b,z) is defined as:

$${γ}_{\pm 1} ( w , b , z ) = {min}_{( {x}_{i} , \pm 1 ) ∈ z} \frac{\pm ( 〈 w , {x}_{i} 〉 + b )}{‖ w ‖} \qquad ( 5 )$$

### Where z=((x₁,y₁), . . . ,(xₘ,yₘ))ε(χ×{−1,+1})^{m} is a training sample. φ:χ→κεRⁿ is a feature mapping into an n-dimension vector space κ. xᵢ=φ(xᵢ), wεκ,bεR are parameters. <.,.> denotes the inner product in κ The PAUM Algorithm is provided below.

PAUM Algorithm

```
Require: A linearly separable training sample
z=((x₁,y₁),...,(xₘ,yₘ))∈(χ×{−1,+1})^{m}
Require: A leaning rate η∈R⁺
Require: Two margin parameters τ₋₁,τ₊₁ ∈R⁺
                    R = maxₓ_{ᵢ} ||xᵢ||
w₀ = 0; b₀ = 0; t = 0;
repeat
for i = 1 to m do
        if ^{y}ᵢ^{(<w}ₜ^{,x}ᵢ^{> + b}ₜ^{) ≦ τ}_{y}_{ᵢ} then
          wₜ₊₁ = wₜ + ηyᵢxᵢ
          bₜ₊₁ = bₜ + ηyᵢR²
          t [symbol] t + 1
        end if
        end for
until no updates made within the for loop
return (wₜ, bₜ)
```

At step 212, templates 108 can be optionally extracted from the derived question paraphrases using template generator 110. As mentioned above, paraphrases are identified from each cluster in which a common content word w is shared by all questions. Hence, the paraphrase templates 108 are formalized by simply replacing the index word w with a wildcard “*”. For example, the questions “What is the length of Nile?” and “How long is Nile?” are recognized as paraphrases from the cluster indexed by “Nile”. Then the paraphrase template “What is the length of *

[symbol]

### How long is *” is reproduced by replacing “Nile” with “*”.

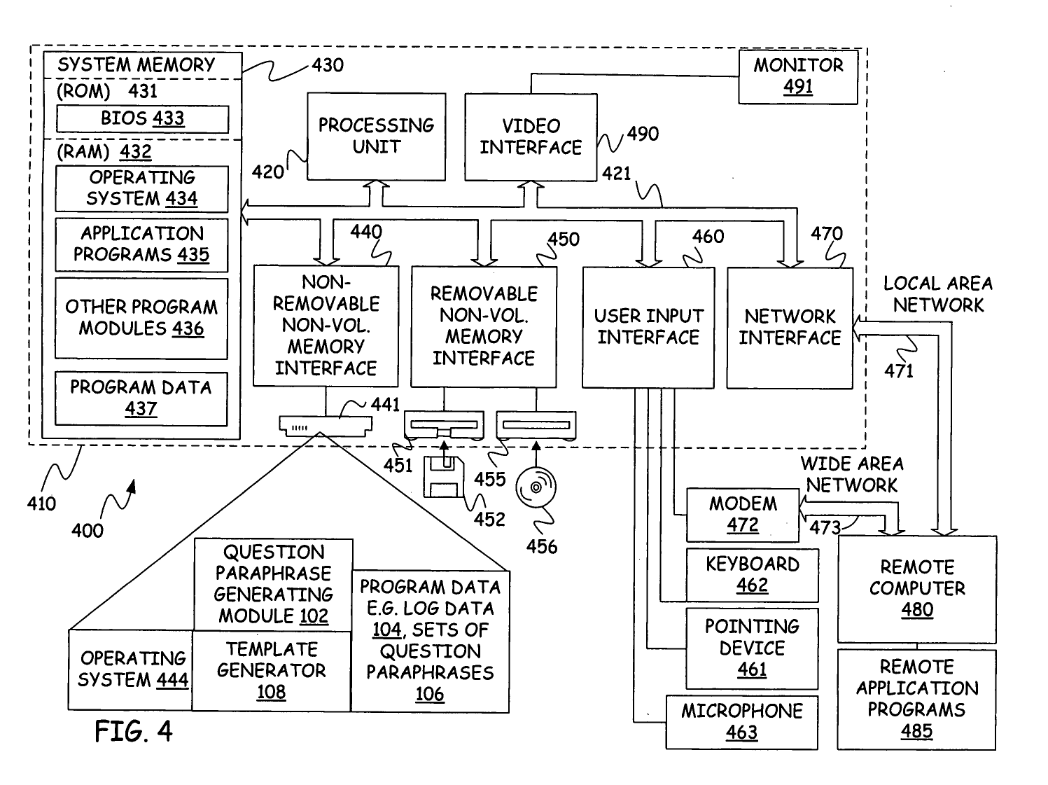

FIG. 4 illustrates an example of a suitable computing system environment 400 on which the concepts herein described may be implemented. In particular, computing system environment 400 can be used to implement question paraphrase generating module 102 and template generator 108 as well as store, access and create data such as data 104 and sets of question paraphrases 106 as illustrated in FIG. 4 and discussed in an exemplary manner below. Nevertheless, the computing system environment 400 is again only one example of a suitable computing environment for each of these computers and is not intended to suggest any limitation as to the scope of use or functionality of the description below. Neither should the computing environment 400 be interpreted as having any dependency or requirement relating to any one or combination of components illustrated in the exemplary operating environment 400.

In addition to the examples herein provided, other well known computing systems, environments, and/or configurations may be suitable for use with concepts herein described. Such systems include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The concepts herein described may be embodied in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

The concepts herein described may also be practiced in distributed computing environments where tasks are performed by remote processing devices that are linked through a communications network. In a distributed computing environment, program modules may be located in both locale and remote computer storage media including memory storage devices.

With reference to FIG. 4, an exemplary system includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 400.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation,

FIG. 4 illustrates operating system 434, application programs 435, other program modules 436, and program data 437. Herein, the application programs 435, program modules 436 and program data 437 implement one or more of the concepts described above.

The computer 410 may also include other removable/non-removable volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4, provide storage of computer readable instructions, data structures, program modules and other data for the computer 410. In FIG. 4, for example, hard disk drive 441 is illustrated as storing operating system 444, question paraphrase generating module 102, template generator 108 and the data used or created by these modules, e.g. data 104, sets of question paraphrases 106. Note that these components can either be the same as or different from operating system 434, application programs 435, other program modules 436, and program data 437. Operating system 434, application programs 435, other program modules 436, and program data 437 are given different numbers here to illustrate that, at a minimum, they are different copies.

A user may enter commands and information into the computer 410 through input devices such as a keyboard 462, a microphone 463, and a pointing device 461, such as a mouse, trackball or touch pad. These and other input devices are often connected to the processing unit 420 through a user input interface 460 that is coupled to the system bus, but may be connected by other interface and bus structures, such as a parallel port or a universal serial bus (USB). A monitor 491 or other type of display device is also connected to the system bus 421 via an interface, such as a video interface 490.

The computer 410 may operate in a networked environment using logical connections to one or more remote computers, such as a remote computer 480. The remote computer 480 may be a personal computer, a hand-held device, a server, a router, a network PC, a peer device or other common network node, and typically includes many or all of the elements described above relative to the computer 410. The logical connections depicted in FIG. 4 include a locale area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user-input interface 460, or other appropriate mechanism. In a networked environment, program modules depicted relative to the computer 410, or portions thereof, may be stored in the remote memory storage device. By way of example, and not limitation, FIG. 4 illustrates remote application programs 485 as residing on remote computer 480. It will be appreciated that the network connections shown are exemplary and other means of establishing a communications link between the computers may be used.

It should be noted that the concepts herein described can be carried out on a computer system such as that described with respect to FIG. 4. However, other suitable systems include a server, a computer devoted to message handling, or on a distributed system in which different portions of the concepts are carried out on different parts of the distributed computing system.

Although the subject matter has been described in language specific to structural features and/or methodological acts, it is to be understood that the subject matter defined in the appended claims is not limited to the specific features or acts described above as has been held by the courts. Rather, the specific features and acts described above are disclosed as example forms of implementing the claims.

What is claimed is:

1. A computer implemented method for obtaining question paraphrases comprising:
obtaining log data of questions made to a computer based information source; and
identifying question paraphrases from the log data, each question paraphrase comprising at least two questions having different words but embodying substantially the same semantic inquiry.

2. The computer implemented method of claim 1 wherein obtaining log data includes extracting said questions from non-questions in the log data.

3. The computer implemented method of claim 2 wherein identifying question paraphrases includes classifying questions according to question types.

4. The computer implemented method of claim 3 wherein classifying questions according to a type of question word.

5. The computer implemented method of claim 4 wherein classifying questions according to the type of question word comprising a set of who, what, when, where, why, and how.

6. The computer implemented method of claim 4 wherein identifying question paraphrases includes classifying each of the questions classified according to the type of question word into separate.

7. The computer implemented method of claim 4 wherein identifying question paraphrases includes classifying each of the questions classified according to the type of question word into separate clusters based on a common word contained in each question.

8. The computer implemented method of claim 4 wherein identifying question paraphrases includes identifying question paraphrases in each cluster.

9. The computer implemented method of claim 4 wherein identifying question paraphrases includes classifying question pairs in each cluster based on at least one feature of the question pairs.

10. The computer implemented method of claim 9 wherein the log data includes associated information indicative of an answer to each of the questions, and wherein the feature comprises similarity of the information indicative of the answers to the questions.

11. The computer implemented method of claim 9 wherein the feature comprises syntactic similarity of the questions.

12. The computer implemented method of claim 9 wherein the feature comprises similarity of translations of the questions

13. A computer implemented method for obtaining question paraphrases comprising:
obtaining log data of questions made to a computer based information source, wherein log data includes associated information indicative of an answer to each of the questions; and
identifying question paraphrases from the log data, each question paraphrase comprising at least two questions having different words but embodying substantially the same semantic question, and wherein identifying question paraphrases includes ascertaining similarity of the information indicative of the answers to the questions.

14. The computer implemented method of claim 13 wherein identifying question paraphrases includes ascertaining syntactic similarity of the questions.

15. The computer implemented method of claim 14 wherein identifying question paraphrases includes ascertaining similarity of translations of the questions.

16. The computer implemented method of claim 13 wherein identifying question paraphrases includes classifying each of the questions into separate clusters based on a common word contained in each question.

17. A computer implemented method for obtaining question paraphrases comprising:
obtaining log data of questions made to a computer based information source; and
identifying question paraphrases from the log data, each question paraphrase comprising at least two questions having different words but embodying substantially the same semantic question, and wherein identifying question paraphrases includes ascertaining syntactic similarity of the questions.

18. The computer implemented method of claim 15 wherein identifying question paraphrases includes ascertaining similarity of translations of the questions.

19. The computer implemented method of claim 18 wherein identifying question paraphrases includes classifying questions according to a type of question word comprising a set of who, what, when, where, why, and how.

20. The computer implemented method of claim 18 wherein identifying question paraphrases includes classifying each of the questions into separate clusters based on a common word contained in each question.
